(19) United States
(12) Patent Application Publication
(10) Pub. No.: US 2011/0295689 A1
(43) Pub. Date: Dec. 1, 2011

(54) METHODS AND SYSTEMS TO MODIFY ADVERTISING AND CONTENT DELIVERED OVER THE INTERNET

(76) Inventor: James Brady, London (GB)

(21) Appl. No.: 13/115,155

(22) Filed: May 25, 2011

Related U.S. Application Data
(60) Provisional application No. 61/349,756, filed on May 28, 2010.

(51) Int. Cl. G06Q 30/00; G06F 17/30; G06F 15/16

(52) U.S. Cl. 705/14.54; 709/219; 705/14.66; 707/E17.108

(57) ABSTRACT

A method for presenting tailored content to a user, comprising: presenting a central coordinating interface to a client; Generating a portion of client specific computer code, including a unique site identification token for a client site and at least one operating parameter; Integrating the client specific computer code into the client site, serving at least one user the client site having integrated client specific computer code therein and giving the option to download an end-user application; Sending a request with at least one request parameter when a user selects to download the end-user application; Processing the request parameters and the operating parameters to dynamically generate an end-user application; providing the end-user application to the user, which presents tailored content to the user according to at least one of detail, request parameter and operating parameter.

This application claims priority to provisional patent application No. 61/349,756 filed May 28, 2010 and entitled “Method and System to Modify Advertising and Content Delivered Over The Internet”.

This invention relates to methods and systems to modify advertising and content delivered to users on the Internet. The invention is especially useful in improving the efficacy of advertising, and in increasing the usage and engagement of end-users with particular sites.

Increasing the value of advertising inventory is a continuing objective for website owners and advertising networks (referred to collectively as “client sites”).

Increasing the engagement and loyalty that end-users feel towards websites is also a continuing objective for website owners.

There are four main facets to these objectives: increasing the number of new users that choose to explore the website content, tailoring the website content to increase end-user satisfaction, re-targeting advertising to improve the click through rate (CTR), and increasing the number of existing users who choose to return to the website.

Increasing the number of new visitors is generally accomplished through techniques such as advertising on search engine result pages (SERPs), advertising on third party sites, and search engine optimisation (SEO) to ensure good placement in organic search engine results.

Re-targeting website advertising can be accomplished by inferring topics of interest to end-user based on past behaviour

Increasing the number of existing users returning to a website can be accomplished through advertising and SEO, and also through direct contact such as email.

From the website owner's perspective, all of these methods require not only an upfront investment of time and money, but also a large ongoing overhead to maintain efficacy and adapt to changing conditions. Also, end-users only generate revenue for the website while they are actively browsing the website's pages.

From the end-user's perspective, the increasingly intrusive attempts by client sites to drive visitors to a particular website can be distracting and obstructive, and rarely provide value to the end-user.

From the advertising network's perspective, targeting advertising inventory is complicated by the lack of contextual information available, often leading to poor quality, low-efficiency generic advertising.

Therefore, there exists a need for a method to increase the value of website content, improve the efficacy of advertising and build the engagement and loyalty of end-users.

### SUMMARY OF THE INVENTION

It is an object of this invention to provide a method of re-targeting advertising based on end-user preferences and behaviour.

It is an object of this invention to present methods and systems to assist website owners to increase the engagement and loyalty of end-users.

It is an object of this invention to provide methods for website owners to generate revenue from advertising not shown directly on their website.

It is an object of this invention to dynamically create end-user applications, according to parameters supplied by client sites and garnered from the installation environment.

It is an object of this invention to supply client sites with a method to initiate the automatic creation of a dynamic end-user application.

It is an object of this invention to provide a coordinating website allowing client sites to configure general parameters of an end-user application.

It is an object of this invention to provide end-users with a method to install an automatically created end-user application.

The end-user application may take the form of a browser add-on. The specifics of the end-user application are determined by the initial configuration supplied to the coordinating website and contextual data gleaned from the environment the application is installed in.

After installation, the operation of the end-user application may be determined by some or all of the following: the initial configuration supplied by the website owner to the coordinating website, contextual data available during the install process, past and current contextual data available during the application's operation, data from the coordinating website, and data from the content-based website.

The end-user application may customise, augment, or otherwise modify SERPs according to the supplied configuration. This modification may include the inclusion of targeted advertising, either from participating websites' inventory or a 3^{rd} party supplier.

The end-user application may customise, augment, or otherwise modify the content of arbitrary website pages.

Modification of arbitrary web pages and SERPs may include promotion of complementary participating websites, not necessarily directly related to the website from which the end-user obtained the application.

Websites may tailor content, re-target advertising or otherwise modify aspects of their user experience based on customisation data supplied by the end-user application.

An advantage of this invention is that publishers can earn an ongoing advertising revenue stream from their readers, rather than only earning revenue when said readers view a page on their site.

An advantage of this invention is that the end-user application is created automatically and dynamically, on a per-user basis, to give an entirely personalised experience to the user, without onerous overhead for the website owner.

An advantage of this invention is that publishers can increase the value of their audience to their advertisers, by being able to target their advertising based on the users' behavior (re-targeting).

An advantage of this invention is that client sites do not need to create tailored versions of the end-user application for different sections or facets or a website.

An advantage of this invention is that the end-user application may be responsive to changing context over time, obviating the need to manually adapt the end-user application to the environment it is operating in.

An advantage of this invention is that participating website owners can acquire new users and new audiences through targeted promotion in end-user applications.

According to one embodiment of the present invention, a method for presenting tailored content to a user is provided, comprising the steps of: presenting a central coordinating interface to a client, wherein the client agrees to participate; generating, by the central coordinating interface, a portion of client specific computer code, wherein the client specific computer code includes a unique site identification token for a client site and at least one operating parameter; Integrating the client specific computer code into the client site, wherein at least one user of the client site is served the client site having integrated client specific computer code therein and given the option to download an end-user application; sending a request to the central coordinating interface when a user selects to download the end-user application, wherein the request contains at least one request parameter; Processing, by the central coordinating interface, at least one of the at least one request parameter and the at least one operating parameter to dynamically generate an end-user application to the user; providing the end-user application to the user, wherein the end-user application presents tailored content to the user according to at least one of the at least one request parameter and the at least one operating parameter.

According to another embodiment of the present invention, a computer implemented system for generating and presenting tailored content for presentation to a user is provided, the system comprising: a central coordinating interface which generates a portion of client specific computer code which includes a unique site identification token for a client site and at least one operating parameter; a client site having the client specific computer code integrated therein, wherein at least one user of the client site is served the client site having integrated client specific computer code therein and given the option to download an end-user application; a computer-implemented request is sent to the central coordinating interface when a user selects to download the end-user application, wherein the request contains at least one request parameter; wherein the central coordinating interface processes at least one of the at least one request parameter and the at least one operating parameter to dynamically generate an end-user application to the user; an end-user application is provided to the user, wherein the end-user application presents tailored content to the user according to at least one of the at least one request parameter and the at least one operating parameter.

These and other features, aspects and advantages of the present invention will become better understood with reference to the following description and claims.

### BRIEF DESCRIPTION OF THE DRAWINGS

FIG. 1 depicts one embodiment of the present invention;

FIG. 2 depicts one embodiment of the process of a client site choosing to participate in the present invention, and performing the initial configuration steps;

FIG. 3 depicts one embodiment of the install process of an end-user application;

FIG. 4 depicts one embodiment of the operation of the invention; in particular the augmentation of a search engine results interface;

FIG. 5 depicts one embodiment of the operation of the invention; in particular, the customisation of a client site's operation based on configuration and contextual data;

FIG. 6 depicts one embodiment of the operation of the invention; in particular, the customisation of a client site interface by the end-user application, based on configuration and contextual data; and

FIG. 7 depicts one embodiment of the operation of the management interface.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

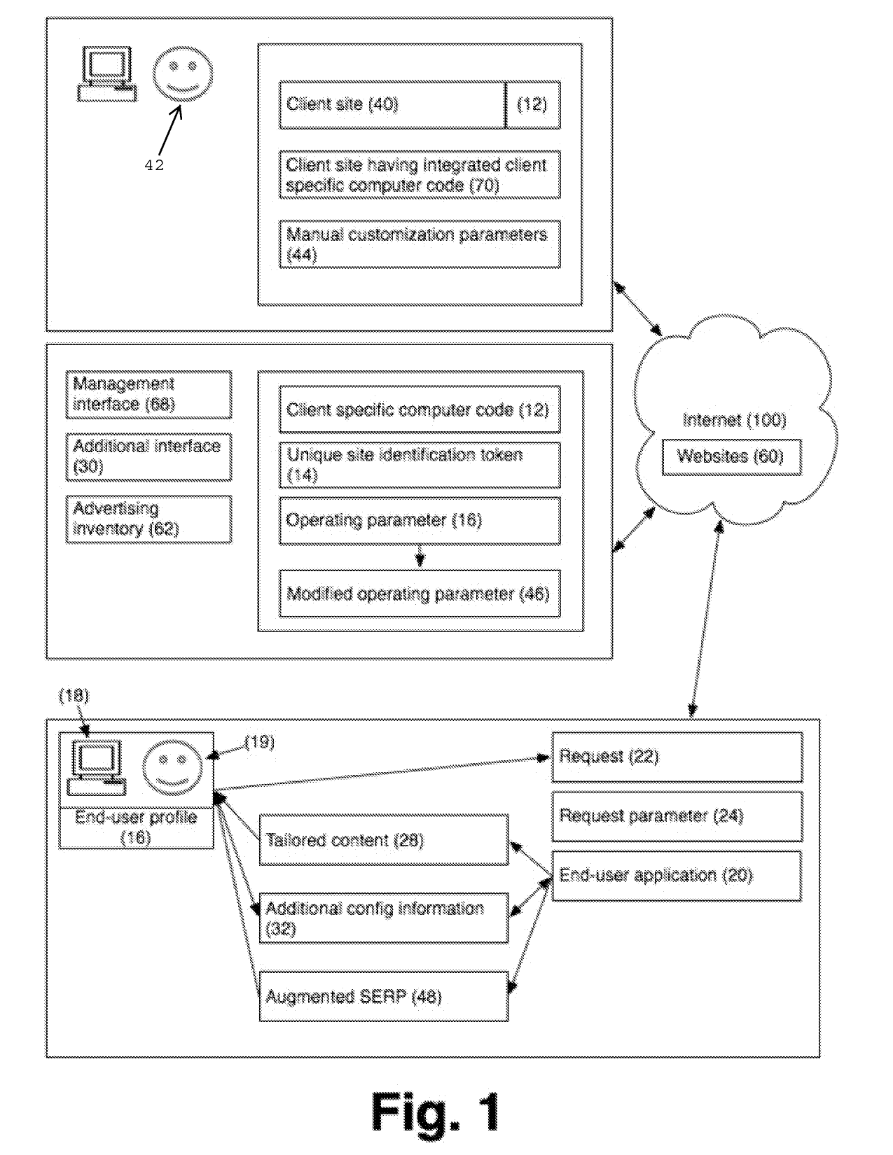

With reference to FIG. 1, presented are methods and systems of increasing the value of online advertising inventory and improving the exposure of website content to end-users. The three essential agents in this invention are a coordinating website (e.g. central coordinating interface (10)), various content-based websites (e.g. client site (40)), and various end-user applications (e.g. end-user application (20)). As a user (e.g. 18) is interacting with a particular content-based website, they may be presented with an option to have similar content presented to them while not directly interacting with said website. When the end-user selects this option, an end-user application is automatically generated “on the fly” by a coordinating website, tailored to the specific needs to this end-user and this content-based website. Henceforth, selected data from the content-based website and other sources will be presented by the application to the user at opportune moments, and the website will refine its content and tailor its advertising for each end-user.

A central coordinating website presents an interface (e.g. a central coordinating interface (10) with which client sites (e.g. 40) can choose to participate in this system. Client sites can optionally supply manual customisation parameters to the coordinating website, including but not limited to settings such as a name, branding, and whether to enable cross-promotion of other participating sites.

A snippet of computer code is returned to the client site to be used directly in a specific website or included in an advertising network's inventory. The code will include a unique site identification token. The website owner integrates said computer code into their website, so that some or all of the users are served this code. When the code is served, the user is given an option to download an end-user application tailored to this particular website. When a user selects the option to download an end-user application, a request is made to the coordinating website, containing parameters such as the unique identification token, the page address (URL), the content of the page, data from the user's browsing session, and other data embedded in the code or harvested from the context of the end-user. The coordinating website will process the parameters supplied to it from the end-user's browser to dynamically generate an end-user application according to these configuration data, including a unique application identification token. Optionally, the coordinating website may also use the site identification token to load and process extra configuration supplied previously by the client site. Some, all or none of the operating parameters of this end-user application are stored in the coordinating website, identified by the unique application identification token. The dynamically generated application is returned to the end-user, to be installed on their device.

The end-user application may interface with the user, by way of example, through: a toolbar embedded in the window of a web browser; button embedded in the window of a web browser which opens a pane hovering over the browser window when clicked; a button embedded in the window of a web browser which opens a new window when clicked. On web pages, the application may change the content of the web page itself, for example: remove some content from the page that is deemed to be uninteresting; add new content to the page that is deemed to be interesting; remove some advertising from the page that is deemed to be uninteresting; add new advertising to the page that is deemed to be interesting; a desktop application that displays interesting content and advertising based on context gathered as the user has been browsing; a mobile application that displays interesting content and advertising based on context gathered as the user has been browsing; an alerting application that notifies the user when new, timely, interesting content becomes available; notifications may take the form of: email; windows opened on the user's device; SMS messages; Tweets or other online notifications such as RSS; List of data the end-user application may collect as it operates: location of the user; web pages bookmarked by the user; web browsing history of the user; content on pages viewed by the user; explicit or implicit indications of engagement with content, for example: sharing links through Twitter, Facebook, or other sharing schemes; length of time spent looking at a web page, and activity on said web page; clicking on links, including advertising links; purchases made by the end-user.

According to one aspect of the present invention, a computer implemented system for generating and presenting tailored content for presentation to a user is provided, comprising: a central coordinating interface (10) which generates a portion of client specific computer code which includes a unique site identification token (14) for a client site and at least one operating parameter (16); a client site (40) having the client specific computer code (12) integrated therein, wherein at least one user (18) of the client site is served the client site having integrated client specific computer code (70) therein and given the option to download an end-user application (20); a computer-implemented request (22) is sent to the central coordinating interface (10) when a user selects to download the end-user application (20), wherein the request contains at least one request parameter (24); wherein the central coordinating interface (10) processes at least one of the at least one request parameter (24) and the at least one operating parameter (16) to dynamically generate an end-user application (20) to the user (18). At least one detail (26) of the end-user application (20) may be stored in the central coordinating interface (10) as an operating parameter (16) with the unique site identification token (14); an end-user application (20) may be provided to the user (18), wherein the end-user application (20) presents tailored content (28) to the user (18) according to at least one of the at least one request parameter (24) and the at least one operating parameter (16).

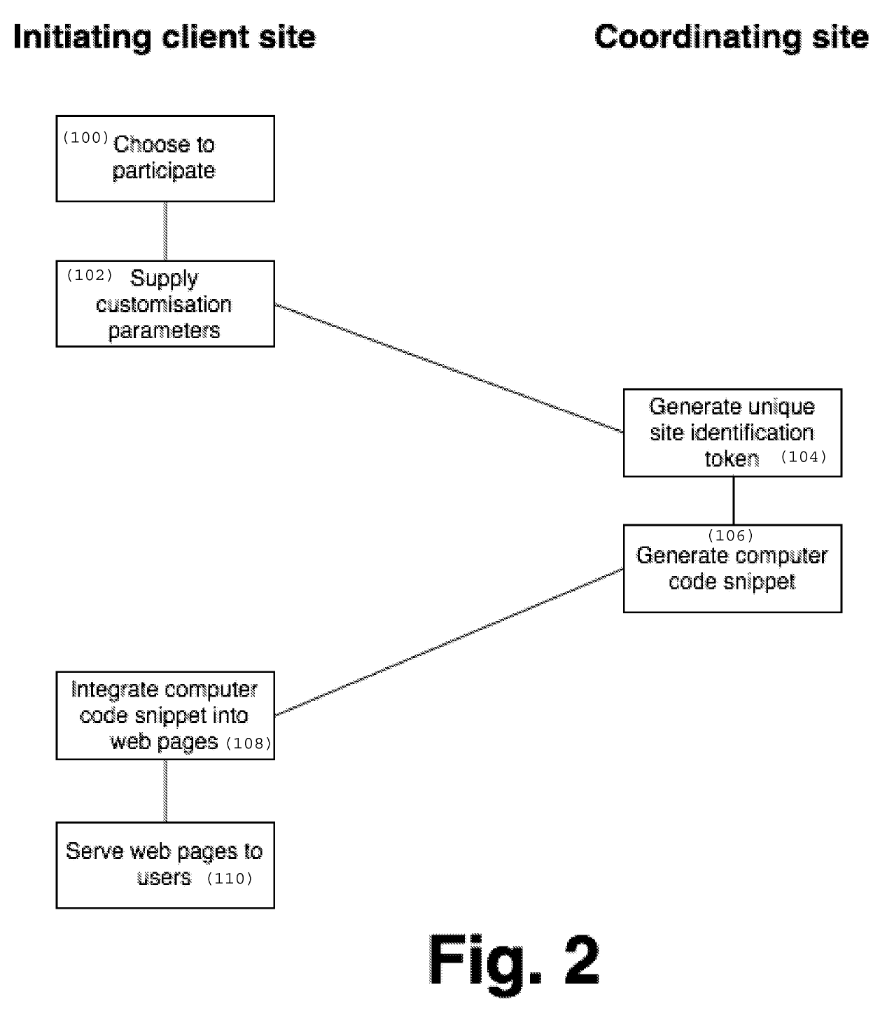

FIG. 2 depicts one embodiment of the process of a client site choosing to participate in the present invention, and performing the initial configuration steps. The client (42) may choose to participate (100) and supply customisation parameters (102), the coordinating site (10) will then generate a unique site identification token (104) and generate a snippet of computer code (106). The next step is to integrate the computer code snippet into webpages (108) and finally serve web pages to users (110).

The end-user application (20) may be installed on the users (18) computer (19). There may be an additional interface (30). The additional interface (30) may be a toolbar. The client (42) may select and the central coordinating interface (10) may accept from the client manual customization parameters (44) for the client site (40).

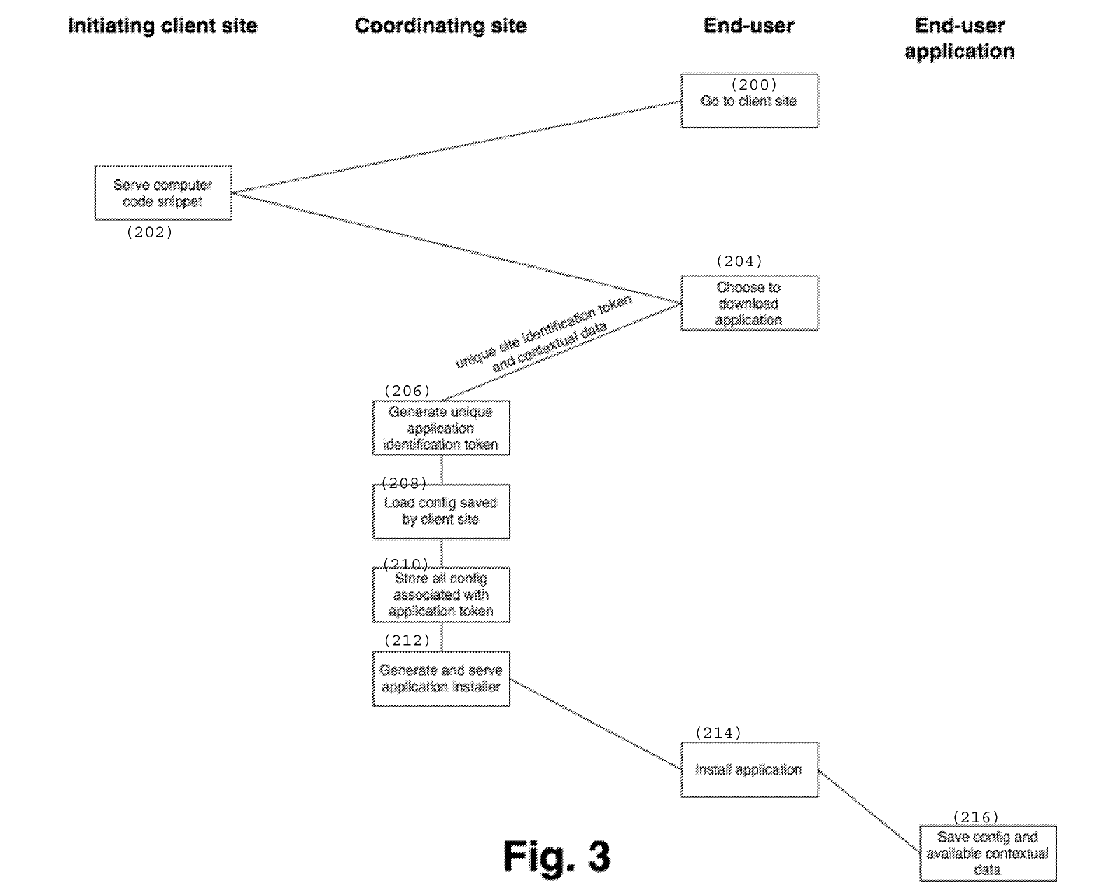

FIG. 3 depicts one embodiment of the install process of an end-user application. The user (18) goes to the client site (200), the initiating client site may (202) serve computer code snippet, the user would then (204) choose to download application, the coordinating site (e.g. central coordinating interface (10)) would (206) generate a unique application identification token and contextual data and the unique site identification token would be communicated between the user and the coordinating site. The step of (208) loading configuration saved by the client site, may be followed by step (210) storing all configuration associated with the application token. The coordinating site would then (212) generate and serve the application installer, the user (18) would (214) install the end-user application and the end-user application would (216) save configuration and available contextual data.

The at least one request parameter (24) may be a unique identification token, a unique application identification token, the page address (URL), the content of the page, data from the user's browsing session, data embedded in the client specific computer code and data harvested from the context of the user.

The end-user application (20) may collect additional configuration information from the user (18) and presents tailored content to the user (18) according to at least one of the at least one detail (26), the at least one request parameter (24) and the at least one operating parameter (16) and the additional configuration information (32). Tailored content may be presented to a user (18) on a computer (19) display screen. It is envisioned that the end-user application with repeat these steps over and over again to provide re-targeted (or tailored) content to the user in response to the information received in the form of at least one request parameter and at least one operating parameter.

The additional configuration information (32) may be selected from the group consisting of manual preferences set by the user, extra contextual data from the installation environment, configuration data received from the central coordinating interface and configuration data received from the client site.

The at least one operating parameter (16) may be modified according to data held in an account on a third party site. The at least one operating parameter (16) may be modified according to at least one term on a webpage from a client site (40) from which the application was initiated to provide at least one modified operating parameter (46); and tailored content (28) may be provided to the user (18) according to the at least one modified operating parameter (46).

There may be at least one augmented search engine result page (SERP) (48) which has been augmented by the end-user application (20) with content from the client site (40). This may be a website directing the user (18) to the client site (40), or any other information from the client (42). The augmented search engine result page (48) may augmented by the end-user application (20) with targeted advertising. The end-user application (20) may also provide a tailored version of the client site (40) when the user (18) is browsing the client site (40). A tailored version of a site (60) may be provided by the end-user application (20) according to a search query performed by the user (18). The tailored version of a site (60) may be provided by the end-user application (20) according to contextual data gathered during the creation and operation of the end-user application (20) to filter content from at least one of a client site (40) and an advertising inventory (62). An augmented site which has been augmented by the end-user application (20) may also be provided to a user (18) with targeted advertising. This would allow the practice of sourcing new advertisements/advertisers and inserting them into arbitrary and targeted websites. All information contained within the central coordinating interface (10) may be stored on any data storage medium, such as a database. Accordingly, any step in the method may further comprise the step of storing information through the central coordinating interface on a data storage medium.

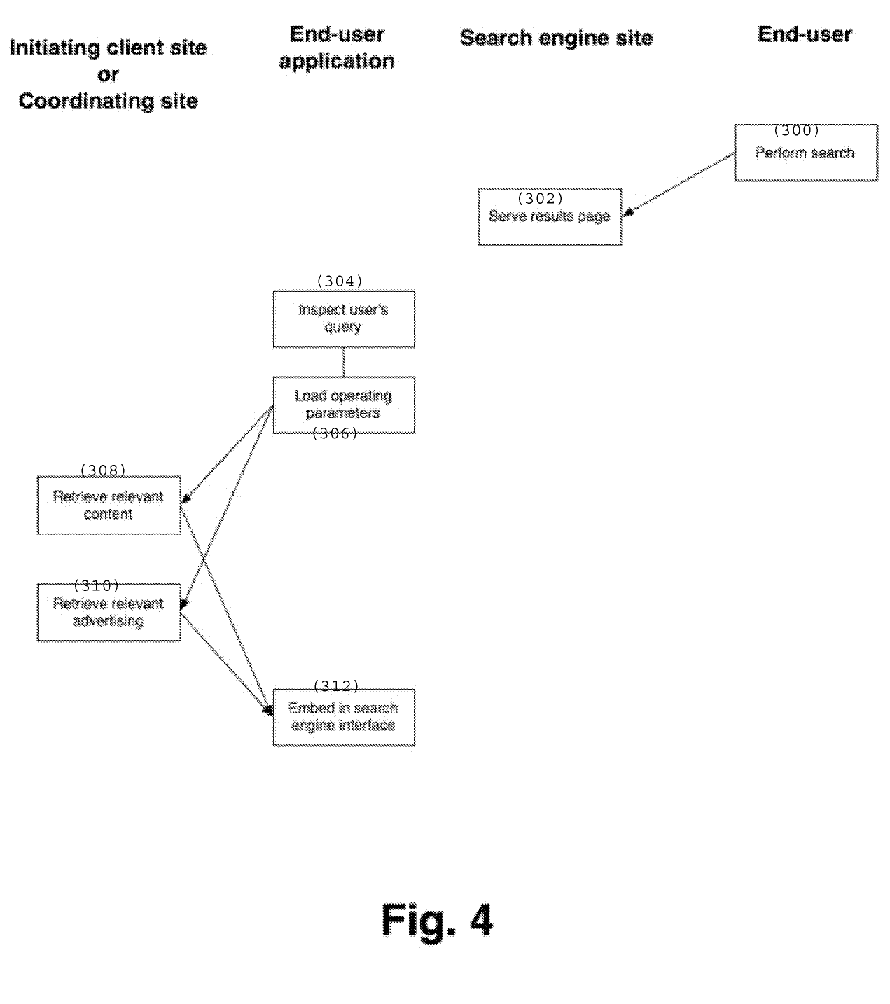

FIG. 4 depicts one embodiment of the operation of the invention; in particular the augmentation of a search engine results interface. The user (300) performs a search, the search engine website (302) serves results page, the end-user application then (304) inspects the user's query and (306) loads operating parameters. The Initiating client site or the coordinating site then (308) retrieves relevant content or (310) retrieves relevant advertising (or both) and the end-user application (312) embeds the content (which may include advertisements) in the search engine interface.

The operating parameters themselves may be stored locally in the end-user application, or stored remotely in the central coordinator. There's an important distinction between the unique site identification tokens and unique application identification tokens; the unique site identification tokens may identify a site, whereas the unique application identification tokens may identify a particular application on a particular end-user's device.

Each client site owner can have several “campaigns” active, and have unique site identification token for each of these. Every time an end-user requests to download an application, the corresponding unique site identification site token is used, and a completely new and completely unique identification application token is generated and used too.

This is important because the operating parameters stored in the central coordinating interface will be unique per application, so the unique identification application token may be used to retrieve these details; as a multitude of applications share the same site token, we wouldn't be able to find the unique parameters for this particular application with just the site token.

As in FIG. 4, the “Load operating parameters” operation may encompass: (1) load unique application identification token (stored locally); (2) load locally stored operating parameters; (3) request operating parameters associated with this application token from the central coordinator; (4) combine the locally stored parameters and those received from the central coordinator.

The operating parameters themselves may be stored locally in the end-user application, or stored remotely in the central coordinator, so the same examples apply for both your first and second questions. Here are some examples: (1) unique application identification token (this is the only parameter that has to be stored locally, to enable look-up of parameters stored with the central coordinator); (2) is this end-user application enabled to augment the current page? (3) should the end-user application insert relevant content, relevant ads or both? (4) what are the topics that the user is most interested in? (5) what is the user's location? (6) what time is it where the user is? (7) what sort of device is the user using?

There may be at least one participating site (which may be a website (60) or a client site (40)), wherein each participating site selects at least one coordinating site (which may also be a website (60) or a client site (40)) from the central coordinating interface (10) and the at least one participating site is provided to a user (18) according to a search query performed by the user (18) and the at least one coordinating site from the central coordinating interface (10).

There may be an end-user profile (66), wherein a tailored version of a site (which may be a website (60) or a client site (40) may be provided by the end-user application (20) according to the end-user profile (66). The end-user profile (66) is stored locally (such as on the users computer (19)), remotely or with a related site.

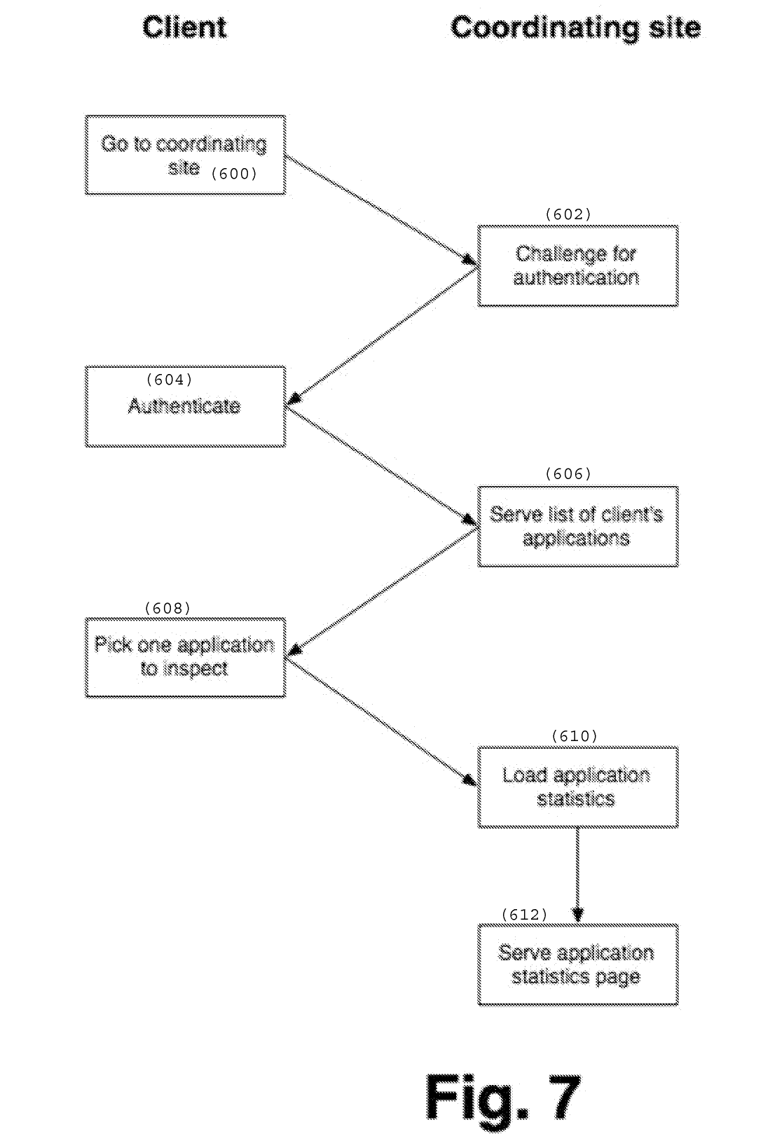

There may be a management interface (68) within the central coordinating interface (10), wherein the management interface (68) displays management information to participating clients (42). Any interface described herein may be, by way of example, a webpage and may also be implemented as desktop applications or mobile applications. The management information may be, for example, the number of applications distributed to end-users, the configuration of the applications distributed to end-users, the observed use and activity for applications distributed to end-users, the additional visits to sites generated by inclusion of their content on search engine results pages, the additional advertising impressions the end-user application has caused, the revenue generated by the applications showing advertising on search engine results pages and the revenue generated by the applications showing advertising elsewhere. FIG. 7 depicts one embodiment of the operation of the management interface. The client (600) goes to the coordinating site, the coordinating site, (602) challenges for authentication, the client site (604) authenticates, the coordinating site (606) serves a list of client's applications, the client (608) picks one application to inspect, the coordinating site (610) loads application statistics and (612) serves application statistics pages.

The present invention also provides methods for presenting tailored content to a user (18), comprising the steps of: presenting a central coordinating interface (10) to a client (42), wherein the client (42) agrees to participate; generating, by the central coordinating interface (10), a portion of client specific computer code (12), wherein the client specific computer code (12) includes a unique site identification token (14) for a client site (40) and at least one operating parameter (16); integrating the client specific computer code (12) into the client site (40), wherein at least one user (18) of the client site (40) is served the client site (40) having integrated client specific computer code (70) therein and given the option to download an end-user application (20); sending a request (22) to the central coordinating interface (10) when a user (18) selects to download the end-user application (20), wherein the request (22) contains at least one request parameter (24); Processing, by the central coordinating interface (10), at least one of the at least one request parameter (24) and the at least one operating parameter (16) to dynamically generate an end-user application (20) to the user (18). There may be the step of storing at least one detail of the end-user application (20) as an operating parameter (16) in the central coordinating interface (10) with the unique site identification token (14); providing the end-user application (20) to the user (18), wherein the end-user application (20) presents tailored content (28) to the user according to at least one of the at least one detail (26), at least one request parameter (24) and at least one operating parameter (16). The request parameter (24) may be, by way of example, a unique identification token, a unique application identification token, the page address (URL), the content of the page, data from the user's browsing session, data embedded in said client specific computer code and data harvested from the context of said user. The end-user application (20) may be installed on the user's computer (19).

Client manual customization parameters may be accepted from the client (42) for the client site (40). There may also be the step of loading and processing additional configuration information supplied by the client site (40) using the unique site identification token (14).

There may also be the steps of collecting additional configuration information from the user (18), wherein the end-user application (20) presents tailored content (28) to the user (18) according to at least one of the at least one detail (26), at least one request parameter (24), at least one operating parameter (16) and the additional configuration information (32). The additional configuration information (32) may be, for example, manual preferences set by the user, extra contextual data from the installation environment, configuration data received from the central coordinating interface and configuration data received from the client site.

The at least one operating parameter (16) may be modified according to data held in an account on a third party website (e.g. 60). The at least one operating parameter (16) may also be modified according to at least one term on a webpage from the client site (40) from which the application was initiated to provide at least one modified operating parameter (46) and tailored content (28) provided to the user (18) according to the at least one modified operating parameter (46).

A search engine result page may be augmented by the end-user application (20) with content from the client site (40). A search engine result page may also be augmented by an end-user application (20) with targeted advertising.

A tailored version of the client site (40) may be provided by the end-user application (20) when the user (18) is browsing the client site (40). The term “Tailored version” is intended to denote a version that is altered specifically for the user and is not a standard version of a site. This is to say, it contains different content (tailored content (28)) than the standard version of the site that would be viewed by a user who does not have the end-user application (20) installed on their computer. A tailored version of a website may be provided by the end-user application (20) when the user is browsing the website. A tailored version of a website may be provided by the end-user application (20) according to a search query performed by the user (18). A tailored version of a website by the end-user application (20) may be provided according to contextual data gathered during the creation and operation of the end-user application (20) to filter content from at least one of the client site (40) and an advertising inventory (62).

There may also be at least one participating site, wherein each participating site selects at least one coordinating site from the central coordinating interface (20); at least one participating site may be provided to a user according to a search query performed by the user (18) and the at least one coordinating site from the central coordinating interface (20).

The method may further comprise the steps of: obtaining an end-user profile (66); and providing a tailored version of a site by the end-user application (20) according to the end-user profile (66). The end-user profile may be stored locally, remotely or with a related site. The end user profile may also be embedded in the users internet browser. The end-user profile may be embedded in the form of a HTTP cookie.

There may be a management interface (68) provided within the central coordinating interface (10), wherein the management interface (68) displays management information to participating clients (42). The management information may be, for example, the number of applications distributed to end-users, the configuration of the applications distributed to end-users, the observed use and activity for applications distributed to end-users, the additional visits to sites generated by inclusion of their content on search engine results pages, the additional advertising impressions the end-user application has caused, the revenue generated by the applications showing advertising on search engine results pages and the revenue generated by the applications showing advertising elsewhere. The at least one site may be augmented by the end-user application with targeted advertising.

During installation of the end-user application (20), the application will collect additional configuration information, which may include manual preferences set by the end-user, extra contextual data from the installation environment, and configuration received from the coordinating website, and the website which initiated the application creation.

During installation of the end user application (20) and throughout its operation, the application may modify its operating parameters based on contextual data held in accounts on remote 3^{rd} party websites (e.g. Facebook, LinkedIn, and Twitter), that can be accessed based on existing user sessions or credentials stored in the browser.

The contextual data may include websites and text phrases that are of interest to a particular user. For example, URLs recently shared by the user on Facebook or Twitter, or salient terms on the web page from which the application creation was initiated. These data may be used to guide what types of advertising or additional content the user would most value. For example, the end-user application may use these data to display personalised advertising, or it may cross-promote other participating sites which best match the collected contextual data.

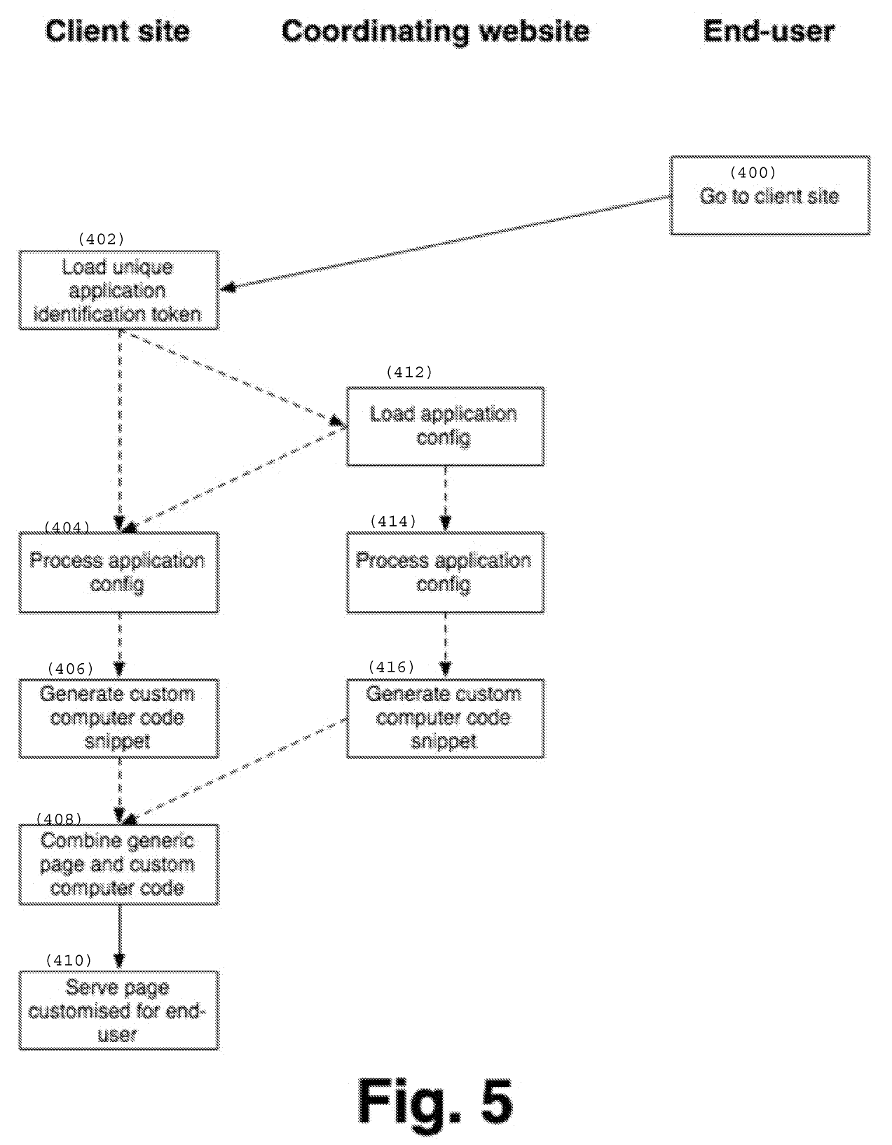

FIG. 5 depicts one embodiment of the operation of the invention; in particular, the customisation of a client site's operation based on configuration and contextual data. Dashed lines represent optional operations, based on the configuration of the entities in the system. The end-user may (400) go to a client site, the client site would (402) load a unique application identification token, the coordinating website would (412) load the application configuration, then (414) process the application configuration and (46) generate a custom computer code snippet, then the client site would (408) combined the generic page and the custom computer code to provide a tailored (or custom) site, then (410) serve the page customized (tailored site having tailored content) for the end-user. Alternatively, the client site would (404) process the application configuration, (406) generate custom computer code snippet(s), (408) combined the generic page and the custom computer code and (410) serve the page customised for the end-user.

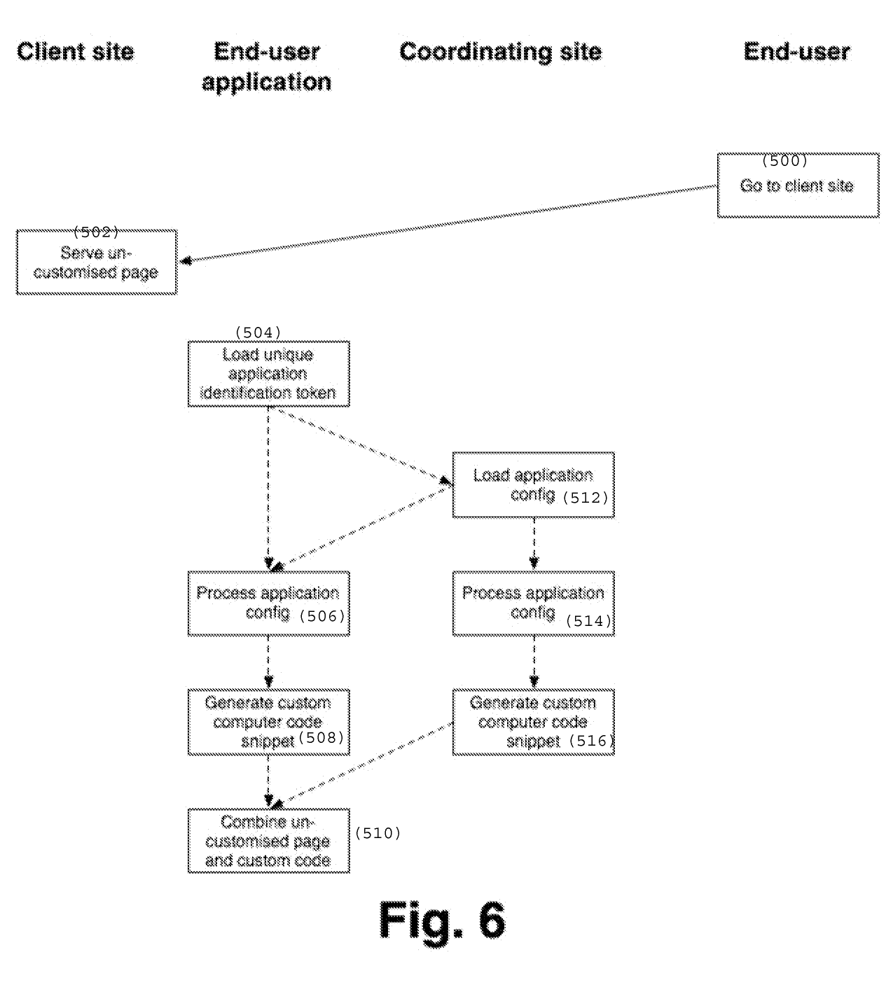

FIG. 6 depicts one embodiment of the operation of the invention; in particular, the customisation of a client site interface by the end-user application, based on configuration and contextual data. Dashed lines represent optional operations, based on the configuration of the entities in the system. The end-user (500) goes to the client site and the client site (502) serves an un-customized (or standard) page. The end-user application would (504) load a unique application identification token and the coordinating site would (510) load the application configuration, (514) process the application configuration, (516) generate custom computer code snippet(s) and (510) combine un-customized page and the custom code to provide tailored content. The end-user application may also (506) process application configuration, (508) generate custom computer code snippet(s) and (510) combine un-customized page and custom code to provide tailored content. Tailored content may be, without limitation and by way of example, a tailored webpage or website, desktop applications, mobile applications, advertisements within any of these,

Depending on the specifics of the configuration, some or all of the following functions will be performed by the end-user application:
(a) SERPs will be augmented with relevant content from the initiating website.
(b) SERPs will be augmented with targeted advertising either from the initiating website's own inventory or from a 3^{rd} party.
(c) SERPs will be augmented with promotions of complementary, participating websites, which may or may not have initiated the creation of this end-user application.
(d) The initiating website will tailor its content to the end-user when said user is browsing the site.
(e) The initiating website will re-target its advertising to better match the interests of the end-user.
(f) Other non-initiating websites that are participating in this system will tailor their content to the end-user.
(g) Other non-initiating websites that are participating in this system will re-target their advertising for the end-user.

One possible implementation of SERPs being augmented with relevant content from the initiating website and with targeted advertising either from the initiating website's own inventory or from a third party is to inspect the query a user has performed, along with contextual data from during the creation and operation of the application to filter content from the initiating website and an advertising inventory respectively.

One possible implementation of SERPs being augmented with targeted advertising either from the initiating website's own inventory or from a 3^{rd} party is to inspect the search query a user has performed, along with contextual data (for example, contextual data from during the creation and operation of the application to filter content from the initiating website and an advertising inventory respectively) and to compare those data with the set of participating websites registered with the coordinating website (e.g. central coordinating interface (10))). If this particular end-user application (20) has been configured to do so, the application (20) may suggest other participating websites that are inferred to be of interest to the end-user.

The augmentation performed as part of: (1) SERPs being augmented with relevant content from the initiating website; and (2) SERPs being augmented with targeted advertising either from the initiating website's own inventory or from a 3^{rd} party; may take the form of an additional interface being presented in the browser chrome, such as a toolbar at the top or side of the content pane; modifications to the SERP being shown in the content pane; an additional interface not directly linked to the web browser window; or in a separate application which may or may not be associated with a web browser.

In order to implement: (1) The initiating website tailoring its content to the end-user when the user is browsing the site; (2) The initiating website will re-target its advertising to better match the interests of the end-user; (3) Other non-initiating websites that are participating in this system will tailor their content to the end-user; and (4) Other non-initiating websites that are participating in this system will re-target their advertising for the end-user; the application will record some amount of end-user information (the profile). This profile will range in scope from the minimal configuration present at install time through to detailed behavioural analysis throughout the operation of the application. This profile may be stored locally, in the end-user application; remotely, on the coordinating server; or a combination of both.

The application may update the local or remote profile data over time, as an end-user's interests and goals change.

One possible implementation of: (1) SERPs being augmented with promotions of complementary, participating websites, which may or may not have initiated the creation of this end-user application; (2) The initiating website tailoring its content to the end-user when the user is browsing the site; (3) The initiating website re-targeting its advertising to better match the interests of the end-user; and (4) Other non-initiating websites that are participating in this system tailoring their content to the end-user; is for the application to embed the profile in the end-user's browser, perhaps in the form of a HTTP Cookie. When an end-user navigates to a participating website, the website will check the available cookies for this profile information. If such a cookie exists, the website will combine the profile with data from the current environment, such as the page content, to produce a representation of the end-user's current interests and goals (the immediate context). The website may display other content and advertising to best complement the immediate context of the end-user.

Another possible implementation of (1) SERPs being augmented with promotions of complementary, participating websites, which may or may not have initiated the creation of this end-user application; (2) The initiating website tailoring its content to the end-user when the user is browsing the site; (3) The initiating website re-targeting its advertising to better match the interests of the end-user; and (4) Other non-initiating websites that are participating in this system tailoring their content to the end-user; is for the end-user application to store the profile with the coordinating website, using the application token to identify itself. The application identification token is embedded in the browser, perhaps in the form of a HTTP Cookie. When an end-user navigates to a participating website, the website will check the available cookies for the application token. If such a cookie exists, the website will query the coordinating website with the token, optionally including data from current environment. The coordinating website will return the immediate context to the website, which may display other content and advertising to best complement the immediate context.

Another possible implementation of (1) SERPs being augmented with promotions of complementary, participating websites, which may or may not have initiated the creation of this end-user application; (2) The initiating website tailoring its content to the end-user when the user is browsing the site; (3) The initiating website re-targeting its advertising to better match the interests of the end-user; and (4) Other non-initiating websites that are participating in this system tailoring their content to the end-user; is for the end-user application to store the profile with the coordinating website, using the application token to identify itself. The application identification token is embedded in the browser, perhaps in the form of a HTTP Cookie. When an end-user navigates to a participating website, the website will check the available cookies for the application token. If such a cookie exists, the website will query the coordinating website with the token, optionally including data from current environment. The coordinating website combines the configuration context associated with the supplied application identification token and any extra context supplied by the site. The coordinating website determines the most apropos content and advertising for the context, and returns suggested content and advertising directly to the website in a form ready for direct display to the user, obviating the need for the website to perform any of the processing itself.

The coordinating website will present a management interface to participating client sites, showing such things as the number of applications distributed to end-users, the configuration of the applications, the observed use and activity for the applications, the additional visits to websites generated by inclusion of their content on SERPs, the additional advertising impressions the end-user application has caused, the revenue generated by the applications showing advertising on SERPs and elsewhere, and various other administrative and statistical displays.

Although the invention is presented in terms of currently accepted standard practices and nomenclature, the invention is not limited in scope to those practices.

By installing a permanent presence on the end-user's device, this invention ensures broader exposure of participating website owners' content to the end-user. It also aids the client sites to tailor and refine the content and advertising shown to users based on inferred and explicit preferences.

An advantage of this invention is that the lifetime value of an end-user is increased for client sites, due to exposing targeted website-content and adverts on SERPs.

A further advantage of this invention is that end-users are conveniently presented with high-value content from their favourite website sources while viewing SERPs.

A further advantage of this invention is that end-users receive a tailored user experience while visiting participating websites, with personally relevant content immediately available.

A further advantage of this invention is that end-users are presented with better, more targeted advertising which enhances their browsing experience, rather than detracting from it.

Note that each step within the present invention may be computer implemented. The computer may be a single computer or a networked group of computers, servers or microprocessors. According to one aspect of the present invention, a non-transitory computer readable medium tangibly embodying a software program or a plurality of software programs may perform the methods described herein.

Although the claimed subject matter has been fully described in connection with examples thereof with reference to the accompanying drawings, it is to be noted that various changes and modifications will become apparent to those skilled in the art. Such changes and modifications are to be understood as being included within the scope of the present disclosure as defined by the appended claims.

1. A method for presenting tailored content to a user, comprising the steps of:
Presenting a central coordinating interface to a client, wherein said client agrees to participate;
Generating, by said central coordinating interface, a portion of client specific computer code, wherein said client specific computer code includes a unique site identification token for a client site and at least one operating parameter;
Integrating said client specific computer code into said client site, wherein at least one user of said client site is served said client site having integrated client specific computer code therein and given the option to download an end-user application;
Sending a request to said central coordinating interface when a user selects to download said end-user application, wherein said request contains at least one request parameter;
Processing, by said central coordinating interface, at least one of said at least one request parameter and said at least one operating parameter to dynamically generate an end-user application to said user;
Providing said end-user application to said user, wherein said end-user application presents tailored content to said user according to at least one of said at least one request parameter and said at least one operating parameter.

2. A method as in claim 1, further comprising the steps of:
accepting from said client manual customization parameters for said client site.

3. A method as in claim 1, wherein said at least one request parameter is selected from the group consisting of a unique identification token, a unique application identification token, the page address (URL), the content of the page, data from the user's browsing session, data embedded in said client specific computer code and data harvested from the context of said user.

4. A method as in claim 1, further comprising the step of:
Loading and processing additional configuration information supplied by said client site using said unique site identification token.

5. A method as in claim 1, wherein said step of providing said end-user application to said user is further comprising the steps of:
Installing said end-user application on said users computer.

6. A method as in claim 5, wherein said step of providing said end-user application to said user is further comprising the step of:
Collecting additional configuration information from said user;
wherein said end-user application presents tailored content to said user according to at least one of said at least one request parameter and said at least one operating parameter and said additional configuration information.

7. A method as in claim 6, wherein said additional configuration information is selected from the group consisting of manual preferences set by said user, extra contextual data from the installation environment, configuration data received from said central coordinating interface and configuration data received from said client site.

8. A method as in claim 1, further comprising the step of:
modifying said at least one operating parameter according to data held in an account on a third party website.

9. A method as in claim 8, further comprising the step of:
modifying at least one operating parameter according to at least one term on a webpage from said client site from which the application was initiated to provide at least one modified operating parameter; and
providing tailored content to said user according to said at least one modified operating parameter.

10. A method as in claim 1, further comprising the steps of:
augmenting at least one search engine result page by said end-user application with content from said client site.

11. A method as in claim 1, further comprising the steps of:
augmenting at least one search engine result page by said end-user application with targeted advertising.

12. A method as in claim 1, further comprising the steps of:
providing a tailored version of said client site by said end-user application when said user is browsing said client site.

13. A method as in claim 1, further comprising the steps of:
providing a tailored version of a website by said end-user application when said user is browsing said website.

14. A method as in claim 1, further comprising the steps of:
providing a tailored version of a website by said end-user application according to a search query performed by said user.

15. A method as in claim 1, further comprising the steps of:
providing a tailored version of a website by said end-user application according to contextual data gathered during the creation and operation of said end-user application to filter content from at least one of said client site and an advertising inventory.

16. A method as in claim 1, further comprising the steps of:
providing at least one participating site, wherein each said participating site selects at least one coordinating site from said central coordinating interface;
providing at least one participating site to a user according to a search query performed by said user and said at least one coordinating site from said central coordinating interface.

17. A method as in claim 1, further comprising the steps of:
obtaining an end-user profile; and
providing a tailored version of a site by said end-user application according to said end-user profile.

18. A method as in claim 17, wherein said end-user profile is stored locally, remotely or with a related site.

19. A method as in claim 17, further comprising the step of:
embedding said end user profile in said users internet browser.

20. A method as in claim 19, wherein said end-user profile is embedded in the form of a HTTP cookie.

21. A method as in claim 1, further comprising the step of:
providing a management interface within said central coordinating interface, wherein said management interface displays management information to participating clients.

22. A method as in claim 21, wherein said management information is selected from the group consisting of the number of applications distributed to end-users, the configuration of the applications distributed to end-users, the observed use and activity for applications distributed to end-users, the additional visits to sites generated by inclusion of their content on search engine results pages, the additional advertising impressions the end-user application has caused, the revenue generated by the applications showing advertising on search engine results pages and the revenue generated by the applications showing advertising elsewhere.

23. A method as in claim 1, further comprising the steps of:
augmenting at least one site by said end-user application with targeted advertising.

24. A method as in claim 1, further comprising the steps of:
Storing at least one operating parameter of said end-user application in said central coordinating interface with said unique site identification token.

25. A computer implemented system for generating and presenting tailored content for presentation to a user, comprising:
a central coordinating interface which generates a portion of client specific computer code which includes a unique site identification token for a client site and at least one operating parameter;
a client site having said client specific computer code integrated therein, wherein at least one user of said client site is served said client site having integrated client specific computer code therein and given the option to download an end-user application;
a computer-implemented request is sent to said central coordinating interface when a user selects to download said end-user application, wherein said request contains at least one request parameter;
wherein said central coordinating interface processes at least one of said at least one request parameter and said at least one operating parameter to dynamically generate an end-user application to said user;
an end-user application is provided to said user, wherein said end-user application presents tailored content to said user according to at least one of said at least one request parameter and said at least one operating parameter.

26. A system as in claim 25, further comprising an additional interface.

27. A system as in claim 26, wherein said additional interface is a toolbar.
accepting from said client manual customization parameters for said client site.

28. A system as in claim 25, wherein said at least one request parameter is selected from the group consisting of a unique identification token, a unique application identification token, the page address (URL), the content of the page, data from the user's browsing session, data embedded in said client specific computer code and data harvested from the context of said user.

29. A system as in claim 25, wherein said end-user application is installed on said users computer.

30. A system as in claim 25, wherein said end-user application collects additional configuration information from said user and presents tailored content to said user according to at least one of said at least one request parameter and said at least one operating parameter and said additional configuration information.

31. A system as in claim 30, wherein said additional configuration information is selected from the group consisting of manual preferences set by said user, extra contextual data from the installation environment, configuration data received from said central coordinating interface and configuration data received from said client site.

32. A system as in claim 25, wherein said at least one operating parameter is modified according to data held in an account on a third party site.

33. A system as in claim 25, further comprising:
at least one operating parameter which is modified according to at least one term on a webpage from said client site from which the application was initiated to provide at least one modified operating parameter; and
tailored content provided to said user according to said at least one modified operating parameter.

34. A system as in claim 25, further comprising:
at least one augmented search engine result page which has been augmented by said end-user application with content from said client site.

35. A system as in claim 25, further comprising:
at least one augmented search engine result page which has been augmented by said end-user application with targeted advertising.

36. A system as in claim 25, further comprising:
a tailored version of said client site provided by said end-user application when said user is browsing said client site.

37. A system as in claim 25, further comprising:
a tailored version of a site provided by said end-user application when said user is browsing said site.

38. A system as in claim 25, further comprising:
a tailored version of a site provided by said end-user application according to a search query performed by said user.

39. A system as in claim 25, further comprising:
a tailored version of a site provided by said end-user application according to contextual data gathered during the creation and operation of said end-user application to filter content from at least one of said client site and an advertising inventory.

40. A system as in claim 25, further comprising:
at least one participating site, wherein each said participating site selects at least one coordinating site from said central coordinating interface and said at least one participating site is provided to a user according to a search query performed by said user and said at least one coordinating site from said central coordinating interface.

41. A system as in claim 25, further comprising:
an end-user profile, wherein a tailored version of a site is provided by said end-user application according to said end-user profile.

42. A system as in claim 41, wherein said end-user profile is stored locally, remotely or with a related site.

43. A system as in claim 25, further comprising:
a management interface within said coordinating interface, wherein said management interface displays management information to participating clients.

44. A system as in claim 43, wherein said management information is selected from the group consisting of the number of applications distributed to end-users, the configuration of the applications distributed to end-users, the observed use and activity for applications distributed to end-users, the additional visits to sites generated by inclusion of their content on search engine results pages, the additional advertising impressions the end-user application has caused, the revenue generated by the applications showing advertising on search engine results pages and the revenue generated by the applications showing advertising elsewhere.

45. A system as in claim 25, further comprising:
at least one augmented site which has been augmented by said end-user application with targeted advertising.

46. A system as in claim 25, wherein at least one operating parameter of said end-user application is stored in said central coordinating interface with said unique site identification token;
